(19) United States
(12) Patent Application Publication
(10) Pub. No.: US 2010/0023887 A1
(43) Pub. Date: Jan. 28, 2010

(54) SYSTEMS AND METHODS FOR COLLECTING AND PROCESSING DIAGNOSTICS AND STATISTICS FOR A FLEET OF TURBINES

(75) Inventors: Christopher Paul Rambosek, Acworth, GA (US); Robert Lee Bonner, JR., Minden, NV (US); Aldo Manuel Hernandez, Woodstock, GA (US); Jien Chin, Overland Park, KS (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 12/178,184

(22) Filed: Jul. 23, 2008

(51) Int. Cl. G06F 3/048

(52) U.S. Cl. 715/772

(57) ABSTRACT

System and methods for displaying data associated with a plurality of power generating devices are disclosed. Data associated with the operation of the plurality of power generating devices is collected from a plurality of data sources. A user request to display data associated with one or more of the plurality of power generating devices is receives and the requested data is formatted for display to the user in response to the received request.

### FIELD OF THE INVENTION

The invention relates generally to monitoring a fleet of turbines, and more specifically, to systems and methods for collecting and processing diagnostics and statistics for a fleet of turbines.

### BACKGROUND OF THE INVENTION

Power generating devices, such as power turbines, are used in a wide variety of applications, such as, in power generation plants. In many conventional applications, it is desirable to monitor certain aspects associated with the operation and/or performance of the utilized power generating devices. This monitoring may be utilized to identify power generating devices that are not operating within desired standards or that fail to meet established performance criteria.

In conventional monitoring systems, a plurality of different monitoring systems are often utilized to monitor various aspects associated with a power generating device. These conventional monitoring systems typically operate independently of one another and provide period reports for a monitored device. For example, a first monitoring system may monitor vibration and combustion diagnostics and track trip statistics for a particular power generating device. The first monitoring system may then provide monthly reports associated with the vibration and combustion diagnostics and the trip statistics for the monitored device. A second monitoring system may monitor the performance of a power generating device and provide bi-monthly optimization reports. Similarly, a third monitoring system may monitor reliability data associated with a power generating device and deliver bi-monthly reports for this data.

These conventional monitoring techniques and systems provide various reports that may be received by a customer at different times. As each of these reports is typically associated with different aspects of a monitored power generating device, a customer is often required to consider multiple reports in order to access the overall performance of a monitored device. Additionally, these conventional reports typically monitor individual power generating devices and do not provide any comparisons between several power generating devices that are operated within a fleet of power generating devices.

Accordingly, there is a need for improved systems and methods for monitoring a power generating device. There is a further need for systems and methods for collecting and processing diagnostics and statistics for a fleet of power generating devices.

### BRIEF DESCRIPTION OF THE INVENTION

According to one embodiment of the invention, there is disclosed a method for displaying data associated with a plurality of power generating devices. Data associated with the operation of the plurality of power generating devices is collected from a plurality of data sources. A user request to display data associated with one or more of the plurality of power generating devices is received. The requested data is formatted for display to the user in response to the received request.

According to another embodiment of the invention, there is disclosed a system for monitoring a plurality of power generating devices. The system includes at least one memory and at least one processor. The at least one memory is operable to store data associated with the operation of the plurality of power generating devices that is collected from a plurality of data sources. The at least one processor is operable to receive a user request to display data associated with one or more of the plurality of power generating devices, to access the at least one memory to retrieve the requested data, and to format the request data for display to the user.

Other embodiments, aspects, features, and advantages of the invention will become apparent to those skilled in the art from the following detailed description, the accompanying drawings, and the appended claims.

### BRIEF DESCRIPTION OF THE DRAWINGS

Having thus described the invention in general terms, reference will now be made to the accompanying drawings, which are not necessarily drawn to scale, and wherein:

FIG. 1A is a schematic diagram of one example of a system for monitoring a fleet of power generation devices, according to an illustrative embodiment of the invention.

FIG. 1B is a schematic diagram of another example of a system for monitoring a fleet of power generation devices, according to an illustrative embodiment of the invention.

FIG. 2 is a block diagram of one example of a computing device that may be utilized in various embodiments of the invention.

FIG. 3 is a flowchart of one example of a method for monitoring a fleet of power generation devices, according to an illustrative embodiment of the invention.

FIG. 4 is a flowchart of one example of a method for displaying data associated with one or more monitored power generation devices, according to an illustrative embodiment of the invention.

FIG. 5 is a flowchart of one example of a method for defining user queries for data associated with one or more monitored power generation devices, according to an illustrative embodiment of the invention.

### DETAILED DESCRIPTION OF THE INVENTION

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Disclosed are embodiments of systems and methods for monitoring and/or comparing the performance of a plurality of power generating devices. The operation of a plurality of power generating devices may be monitored and data associated with their operation may be collected. One or more respective devices and/or systems may be utilized to monitor each of the power generating devices, and the data may be collected from the one or more devices and/or systems. The collected data may be stored in one or more suitable memory devices, and the stored data may be formatted for display in response to various requests received from a user. In this regard, all of the desired operational data for a power generating device or a plurality of power generating devices may be formatted for display and displayed to a user. Comparisons of the operational data for a plurality of power generating devices may also be formatted for display and displayed to the user as desired in various embodiments of the invention. Additionally, the operation of one or more power generating devices may be compared to other statistical values associated with a fleet or sub-fleet of power generating devices, such as, average values or relatively top performing values.

The technical effect of the various embodiments of the invention is to format data associated with monitored power generating devices for display. The data may be formatted for display in a way that facilitates comparisons of data associated with various power generating devices and/or groups of power generating devices.

For purposes of this disclosure, the terms “power generating device,” “power generation device,” and “power turbine” may be used interchangeably. Additionally, embodiments of the invention may be utilized to monitor the performance of a wide variety of different power generating devices, including but not limited to, gas turbines, steam turbines, and/or wind turbines. The systems, methods, and techniques described in embodiments of the invention may be utilized to monitor a wide variety of different types of power generation devices, such as, gas turbines, steam turbines, wind turbines, etc. Additionally, a single system may facilitate the monitoring of multiple types of power generation devices.

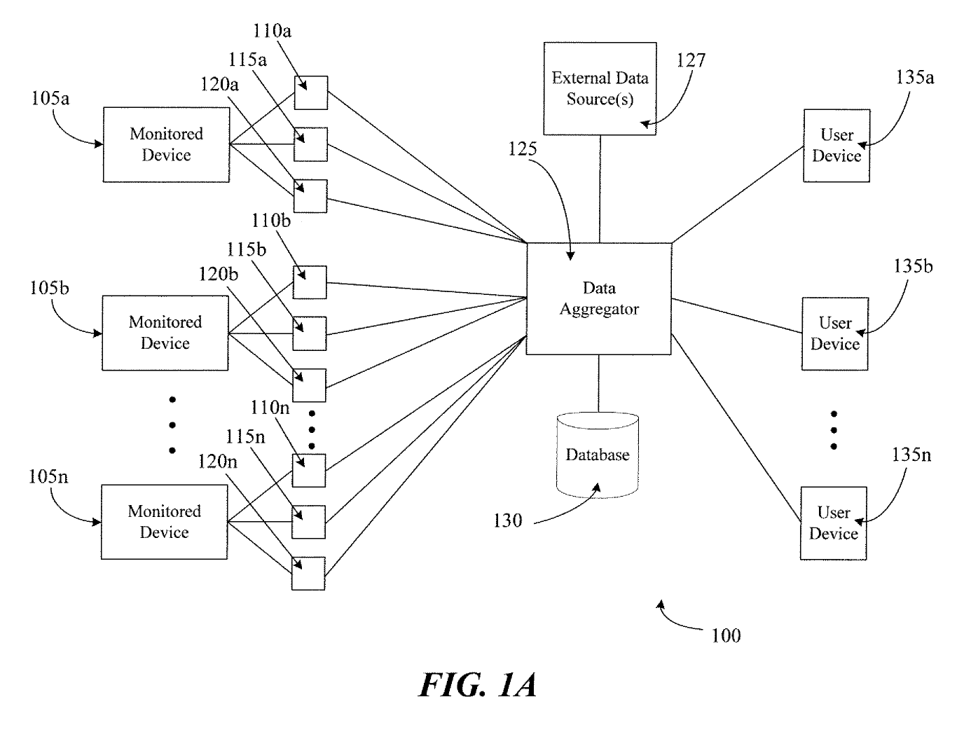

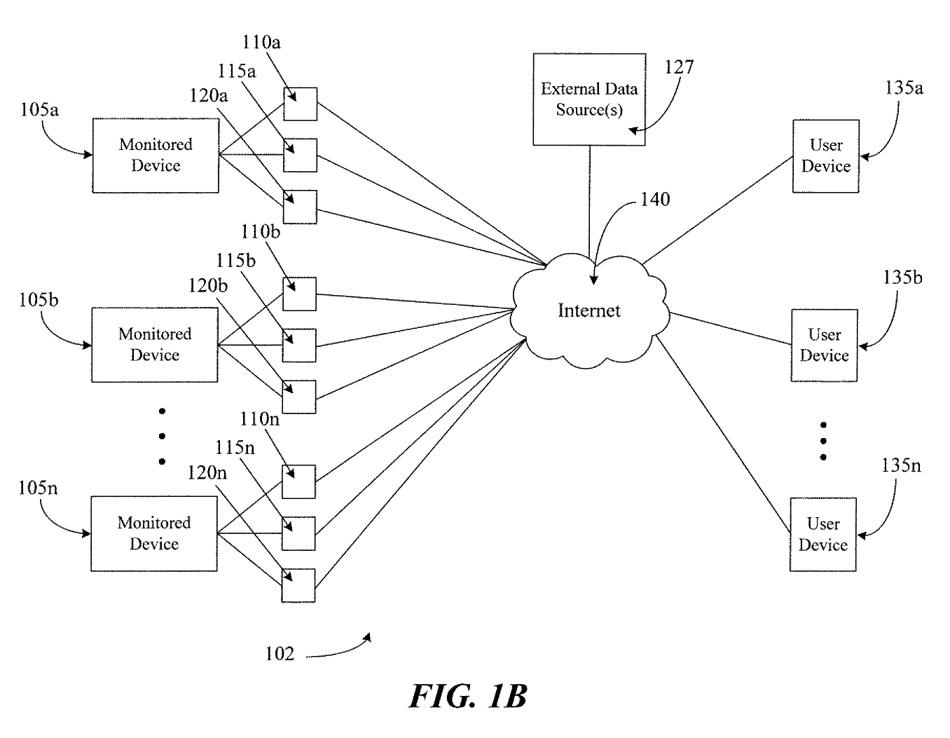

FIG. 1 is a schematic diagram of one example of a system 100 that may be utilized to monitor a plurality of power generation devices 105A-N, according to an illustrative embodiment of the invention. The system 100 may include one or more monitored devices 105a-n, one or more respective data collection devices or systems 110a-n, 115a-n, and 120a-n, a data aggregator 125, and one or more user devices 135a-n.

The one or more monitored devices 105a-n may be power generating devices, such as gas turbines, that are monitored by the system 100. Any number of power generating devices 105a-n may be monitored as desired in various embodiments of the invention. In certain embodiments of the invention, the monitored devices 105a-n may form one or more fleets of power generating devices. A fleet of power generating devices may include any number, types, and/or models of devices as desired in embodiments of the invention. For example, a fleet of devices may include all gas turbines and steam turbines that are monitored by the system 100. A first sub-fleet may be defined for the gas turbines and a second sub-fleet may be defined for the steam turbines. Alternatively, a first sub-fleet may be defined for a particular make and model of gas turbines, a second sub-fleet may be defined for another make and model of gas turbines, and so on.

Additionally, one or more sub-fleets of power generating devices may be defined within a given fleet of devices or within a given sub-fleet. In the example above in which a sub-fleet is defined for gas turbines, additional sub-fleets may be defined within the gas turbine sub-fleet. These additional sub-fleets may define subsets of the gas turbines, such as, sub-fleets for each respective make and model of gas turbine included in the fleet, sub-fleets for gas turbines located in a respective geographic areas, sub-fleets operated by respective customers or power generation companies, etc. A wide variety of different fleets and/or sub-fleets may be defined as desired in various embodiments of the invention. The examples of fleets and/or sub-fleets that are provided in this disclosure are provided by way of example only.

With continued reference to FIG. 1A, each of the monitored devices 105a-n may be monitored by one or more data collection devices or data collection systems. The various data collection devices or systems 110a-n, 115a-n, and 120a-n may monitor the operation of the monitored devices 105a-n and collect data associated with the operation of the monitored devices 105a-n. As shown, data collection devices 110a, 115a, and 120a may monitor a first monitored device 105a and collect data associated with the first monitored device 105a. Similarly, data collection devices 110b, 115b, and 120b may monitor a second monitored device 105b and collect data associated with the second monitored device 105b, and so forth for the remainder of monitored devices.

Although three collection devices are shown for each respective monitored device 105a-n in FIG. 1A, any number of data collection devices or systems may be utilized to monitor and collect data associated with a given monitored device. Additionally, in certain embodiments of the invention, a plurality of monitored devices 105a-n may be monitored by one or more of the collection devices.

Each of the data collection devices or systems 110a-n, 115a-n, and 120a-n may include any number of sensors or other suitable data collection means that facilitate the collection of data associated with the operation of a monitored device 105a-n. The data collection devices 110a, 115a, and 120a and their operation in conjunction with a first monitored device 105a are described in greater detail herein. The operation of other data collection devices 110b-n, 115b-n, and 120b-n may be similar to that of the data collection devices 110a, 115a, and 120a utilized to monitor the first monitored device 105.

Each of the data collection devices or systems 110a, 115a, and 120a may collect data by directly monitoring the monitored device 105a, by indirectly monitoring the monitored device 105a, and/or by receiving information associated with the operation of the monitored device 105a from one or more other sources. Additionally, each of the data collection devices or systems 110a, 115a, and 120a may continuously collect data in real time or near real time and/or may periodically collect data at predefined time intervals, such as, once a minute, once an hour, once a day, or once a week. For example, each of the data collection devices or systems 110a, 115a, and 120a may be associated with one or more sensors that collect data associated with the operation of the monitored device 105a. Additionally or alternatively, each of the data collection devices or systems 110a, 115a, and 120a may receive data associated with the operation of the monitored device 105a from one or more other sources, such as, one or more control systems associated with the monitored device 105a and/or one or more databases that include data associated with the operation of the monitored device 105a.

Each of the data collection devices or systems 110a, 115a, and 120a may collect a wide variety of data associated with the operation of the monitored device 105a. Data that may be collected includes, but is not limited to, performance parameters associated with the monitored device 115a, alarms associated with and/or triggered by the monitored device 105a, data for events associated with the monitored device 105a, data for one or more counters associated with the monitored device 105a, data associated with product cycles for the monitored device 105a, data associated with duty cycles for the monitored device 105a, customer information for one or more customers associated with the monitored device 105a, and/or any other data or statistical information associated with the monitored device 105a that is desired in various embodiments of the invention.

Additionally, each of the data collection devices or systems 110a, 115a, and 120a may include one or more suitable memory devices that are operable to store collected data. Collected data may be maintained in the one or more memory devices for any predetermined period of time as desired, such as, for one month, six months, one year, five years, etc.

According to one embodiment of the invention, each of the data collection devices or systems 110a, 115a, and 120a may be a system that monitors and collects data associated with the operation of the monitored device 105a. Each of the data collection systems 110a, 115a, and 120a may collect different types of information associated with the monitored device 106a, although it is possible that there will be some overlap of the data collected by the data collection systems 110a, 115a, and 120a. For example, the first data collection system 110a may include a monitoring and diagnostics operations center that collects data associated with vibration and combustion diagnostics. The first data collection system 110a may also collect information associated with trip statistics for the monitored device 105a. Continuing with the example, the second data collection system 115a may include an optimization system and/or service that collects data associated with the performance of the monitored device 105a, and the third data collection system 120a may include a system that collects reliability data associated with the monitored device 105a. Although only three data collection systems 110a, 115a, and 120a are described in this example, additional data collection systems may be utilized in certain embodiments of the invention in order to collect additional data associated with the monitored device 105a.

With continued reference to FIG. 1A, the system 100 may also include a data aggregator 125. The data aggregator 125 may receive a portion or all of the data that is collected by the data collection devices or systems 110a-n, 115a-n, and 120a-n. The data aggregator 125 may be in communication with each of the data collection devices or systems 110a-n, 115a-n, and 120a-n via one or more respective network connections. The various network connections may be any suitable network connections, such as, wired network connections, wireless network connections, local area network connections, wide area network connections, telecommunications network, cellular network connections, radio frequency connections, etc. According to one embodiment of the invention, the network connections may be suitable wide area network connections, such as, Internet connections.

The data collection devices or systems 110a-n, 115a-n, and 120a-n may communicate the collected data to the data aggregator 125 in real time or near real time once the data is collected and/or at predetermined time intervals, such as, once a minute, once an hour, once a day, etc. Alternatively, the data aggregator 125 may periodically poll the data collection devices or systems 110a-n, 115a-n, and 120a-n in order to request the collected data, and the collected data may be communicated to the data aggregator 125 in response to the polling request.

Additionally, the data aggregator 125 may be in communication with one or more external data sources 127 other than the data collection devices or systems 110a, 115a, and 120a. In this regard, the data aggregator 125 may receive information associated with the monitored devices 105a-n from one or more data sources that are not in communication with the monitored devices 105a-n. The one or more external data sources 127 may include a wide variety of information associated with the monitored devices 105a-n. For example, the one more external data sources 127 may include information associated with customers or users that are operating the monitored devices 105a-n. As another example, the one or more external data sources 127 may include data associated with preferred, expected, and/or ideal operating conditions for the monitored devices 105a-n. As yet another example, the one or more external data sources 127 may include data associated with preferred, expected, and/or ideal performance parameters and/or performance characteristics for the monitored devices 105a-n.

In accordance with an aspect of the invention, the data aggregator 125 may store the collected data associated with the operation of the monitored devices 105a-n in one or more suitable memory devices, such as, in a database 130. According to an aspect of the invention, the data may be stored in the database 130 for a predetermined period of time, such as for one month, six months, one year, five years, etc.

According to an aspect of the invention, the data aggregator 125 may facilitate the communication of data associated with the operation of the monitored devices 105a-n to one or more users for display to the one or more users via respective user devices 135a-n. The data may be sorted in accordance with one or more parameters received in user request from a user device, such as device 135a. Alternatively, the data may be sorted in accordance with predefined parameters or predefined views. A predefined view may be selected by a user. Once a user has selected a predefined view or submitted a data sorting request, the data may be formatted for display and communicated to the user device 135a. The formatted data may then be displayed to the user by the user device 135a.

The data aggregator 125 may be in communication with each of the user devices 135a-n via one or more respective network connections The various network connections may be any suitable network connections, such as, wired network connections, wireless network connections, local area network connections, wide area network connections, telecommunications network, cellular network connections, radio frequency connections, etc. According to one embodiment of the invention, the network connections may be suitable wide area network connections, such as, Internet connections. For example, a user may utilize a user device, such as device 135a, to access the data aggregator 125 via the Internet, and data associated with one or more of the monitored devices 105a-n may be formatted for display and displayed to the user as one or more web pages. These one or more web pages may be displayed to the user by the user device 135a via a suitable software program, such as a web browser program. Additionally or alternatively, data may be communicated to a user device 135a in other formats as desired, such as in a .pdf format, as a spreadsheet, as a database file, as a text file, as a word processor file, etc.

According to an aspect of the invention, data may be sorted or filtered in accordance with a wide variety of different criteria. These criteria may include predetermined sorting criteria and/or filters that are selectable by a user and/or sorting criteria and/or filters that are received in one or more requests from a user. In various embodiments of the invention, data may be filtered and/or sorted in a wide variety of ways. For example, data may be filtered by one or more variables or parameters, such as, counters associated with one or more monitored devices 105a-n, operating parameters or physical characteristics associated with one or more monitored devices 105a-n, locations associated with one or more monitored devices 105a-n (e.g., geographical locations and/or locations within power plants), and/or marketing parameters associated with one or more monitored devices 105a-n.

Various counters may be associated with the monitored devices 105a-n as desired in various embodiments of the invention. These counters may be associated with individual monitored devices or, alternatively, with groups, sub-fleets, or fleets of monitored devices. For example, one counter may be utilized to indicate a number of trips or faults associated with a monitored device, such as device 105a. Another counter may then be utilized to indicate a number of trips or faults associated with a fleet of monitored devices. Certain of the counters associated with trips or faults may facilitate determining whether and/or when repairs and/or maintenance should be performed on a monitored device or group of monitored devices. Other counters may include, but are not limited to, counters for starts, trips, and/or operating hours.

Additionally, a wide variety of operating parameters or physical characteristics may be associated with one or more monitored devices 105a-n in various embodiments of the invention. These parameters and characteristics may include any parameters associated with the operation and/or performance of one or more monitored devices 105a-n. For example, these parameters and characteristics may include, but are not limited to, parameters associated with output power, heat rate, combustion system operating temperatures, etc.

Additionally, a wide variety of data associated with the location of one or more monitored devices 105a-n may be utilized as desired in various embodiments of the invention. Data may be associated with the location of individual power generating devices or with groups of power generating devices, such as, fleets or sub-fleets of power generating devices. The location data may include, but is not limited to, data associated with a power plant in which one or more monitored devices 105a-n are located, data associated with a city in which one or more monitored devices 105a-n are located, data associated with a zip code in which one or more monitored devices 105a-n are located, data associated with a state in which one or more monitored devices 105a-n are located, and/or data associated with a country in which one or more monitored devices 105a-n are located.

A wide variety of data associated with marketing parameters for the one or more devices 105a-n may also be utilized in various embodiments of the invention. The marketing parameters or marketing data may be associated with individual power generating devices or with groups of power generating devices, such as, fleets or sub-fleets of power generating devices. Examples of marketing parameters include, but are not limited to, parameters that compare user-defined subsets of a monitored fleet against the entire population of a monitored fleet.

According to an aspect of the invention, respective predefined display formats may be associated with any number of filters and/or sorts. These predefined display formats may include display formats that are pre-stored by the data aggregator 125 and/or display formats that are requested by a user and saved by the data aggregator 125.

Data may be presented for either individual power generating devices or for groups of power generating devices. Additionally, data may be presented in a format that allows a user to view and compare data associated with a plurality of monitored devices 105a-n. For example, a display may allow a first monitored device 105a be compared to a second monitored device 105b. As another example, a display may allow a first monitored device 105a to be compared to a fleet of monitored devices 105a-n. As another example, a display may allow one group of monitored devices to be compared to another group of monitored devices. In this regard, comparisons may be made between the monitored devices. Additionally, a display may facilitate the comparison of the performance of one or more monitored devices to the average performance of a group of monitored devices (e.g., a fleet), to the relatively best or top performing monitored devices within a group of monitored devices, to the relatively worst or lowest performing monitored devices within a group of monitored devices, and/or to prestored expected performance parameters for the monitored devices.

According to an aspect of the invention, data for the one or more monitored devices 105a-n may be filtered and/or sorted for predetermined and/or received ranges of time. For example, data for the prior week, prior month, prior six months, or prior year may be filtered and/or sorted and then formatted for display. Additionally, data trends over a range of time may be determined and formatted for display in any suitable format as desired in various embodiments of the invention, such as, in reports, graphs, and/or charts. Examples of trends that may be determined include, but are not limited to, trends associated with vibration data, trends associated with combustion data, trends associated with performance data, and/or trends associated with alarm events.

In certain embodiments of the invention, the data aggregator 125 may generate one or more reports associated with collected data for the one or more monitored devices 105a-n. These reports may be embodied in many different formats, such as, in a spreadsheet format, as a chart, and/or as a graph.

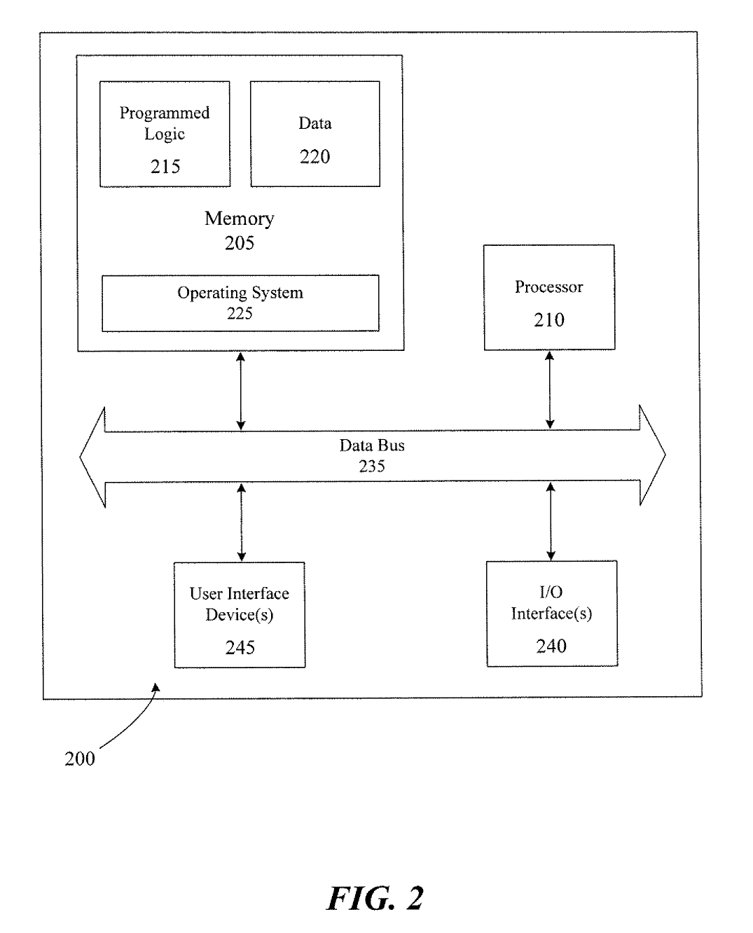

According to an aspect of the invention, various components of the system 100, such as the data collection devices or systems 110a-n, 115a-n, and 120a-n, the data aggregator 125, the external data sources 127, and/or the user devices 135a-n, may include one or more processor-driven devices, such as a personal computer, laptop computer, handheld computer and the like. An example of an architecture of a processor-driven device is provided below with reference to FIG. 2.

FIG. 1B is a schematic diagram of another example of a system 102 for monitoring a fleet of power generation devices 105a-n, according to an illustrative embodiment of the invention. The system 102 depicted in FIG. 1B may be substantially similar to the system 100 depicted in FIG. 1A, except the system 102 depicted in FIG. 1B may not include a data aggregator 125 that facilitates the communication of data between data collection devices or systems 110a-n, 15a-n, and 120a-n and user devices 135a-n. Instead, the user devices 135a-n may communicate directly with the data collection devices or systems 110a-n, 115a-n, and 120a-n and/or one or more external data sources 127 via one or more suitable networks, such as the Internet 140.

In the system 102 depicted in FIG. 1B, each of the respective user devices 135a-n may receive collected data, sort the received data, and/or format the data for display. One or more suitable software programs or software suites may be utilized by the user devices 135a-n in order to collect, sort, and format data for display. For example, a software program may be supplied to a user by a manufacturer (e.g., the General Electric Company) of a monitored device, such as device 105a. The software program may be installed on a user device, such as device 135a, and the software program may facilitate the collection, sorting, and/or displaying of the data associated with the monitored device 105a and/or other monitored devices 105b-n. In this regard, the software may perform similar operations to those described above with reference to FIG. 1A for the data aggregator 125. Additionally, in certain embodiments of the invention, the data accessible by the software and the user devices 135a-n may be determined by one or more security parameters associated with the user. In this regard, the user access to data associated with monitored devices 105a-n that are not owned, operated, and/or controlled by the user may be limited or otherwise regulated.

Those skilled in the art will appreciate that the systems depicted and described with respect to FIGS. 1A and 1B are provided by way of example only. Numerous other systems, operating environments, system architectures, and device configurations are possible. Accordingly, the example embodiments of the invention should not be construed as being limited to any particular system, operating environment, system architecture, or device configuration.

FIG. 2 depicts a block diagram of one example of a computing device 200 or processor-driven device that may be utilized in accordance with various components of embodiments of the invention. The control unit 200 may be a control unit associated with the data aggregator 125, one or more user devices 135a-n, one or more data collection devices or systems 110a-n, 115a-n, and 120a-n, and/or one or more external data sources 127. Any number of computing devices 200 may be utilized as desired in various embodiments of the invention.

The computing device 200 of FIG. 2 may include a memory 205 and a processor 210. The memory 205 may store programmed logic 215 (e.g., software) in accordance with the invention. One example of software or a computer-readable medium for a computing device 200 associated with a data aggregator, such as aggregator 125, may be program code or a set of instructions operable to receive and process data sorting request in order to format data associated with monitored devices for display. Other types of software will be readily apparent to those skilled in the art. The memory 205 may also include data 220 utilized in the operation of the embodiment, and may also include an operating system 225. Utilizing the example of a computing device 200 associated with a data aggregator 125, the data 220 may include collected data associated with one or more monitored devices, such as devices 105a-n. The processor 210 may utilize the operating system 225 to execute the programmed logic 215, and in doing so, may also utilize the data 220. A data bus 230 may provide communication between the memory 205 and the processor 210. Users may interface with the computing device 200 via one or more user interface device(s) 235 such as a keyboard, mouse, control panel, or any other devices capable of communicating digital data to or from the computing device 200. The computing device 200 may communicate with external devices, such as other components of the system 100 depicted in FIG. 1A, via one or more appropriate interface devices 240. Data may also be output by the computing device 200 utilizing one or more suitable output devices, for example, a display. Further the computing device 200 and the programmed logic 215 implemented thereby may comprise software, hardware, firmware or any combination thereof.

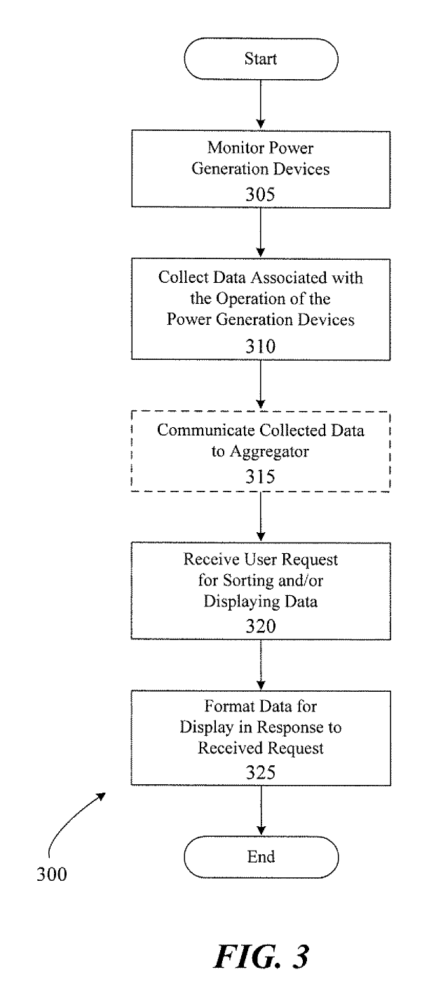

FIG. 3 is a flowchart of one example of a method 300 for monitoring a fleet of power generation devices, according to an illustrative embodiment of the invention. The method may begin at block 305.

At block 305, one or more power generating devices, such as devices 105a-n shown in FIGS. 1A and 1B, may be monitored. Data associated with the operation of the monitored power generating devices may be collected at block 310. The data may be collected by one or more suitable data collection devices or systems, such as 110a-n, 115a-n, and 120a-n shown in FIGS. 1A and 1B. Additionally, data associated with the monitored power generating devices may be collected by other systems that are not monitoring the operation of the power generating devices. Following the collection of the data associated with the monitored power generating devices at block 310, operations may continue at block 315.

At block 315, which may be optional in certain embodiments of the invention, the collected data associated with the monitored power generating devices may be communicated to a data aggregator, such as aggregator 125 illustrated in FIG. 1A. The data aggregator 125 may receive the collected data from various sources, including data collection devices or systems and/or external sources. Additionally, the data aggregator 125 may store the received data in one or more suitable memory devices, such as database 130 illustrated in FIG. 1A. Following the communication of data to the data aggregator 125 at block 315, operations may continue at block 320. Alternatively, if no data aggregator is utilized in an embodiment of the invention, then operations may continue at block 320 following block 310. For example, collected data may be communicated from data collection devices or systems and/or external sources to user devices, such as user devices 135a-n shown in FIG. 1B.

At block 320, a user request for sorting, filtering, and/or displaying data associated with one or more of the monitored power generating devices may be received. A user may utilize one or more suitable user interface devices (e.g., keyboard and/or mouse) at a user device, such as user device 135a shown in FIGS. 1A and 1B, to input a request for sorting, filtering, and/or displaying data. In embodiments of the invention that utilize a data aggregator 125, the user request may be communicated to the data aggregator 125 by the user device 135a for processing by the data aggregator 125. In embodiments of the invention that do not utilize a data aggregator 125, the user request may be processed by the user device 135a. A user may select from predefined sorts and/or filters or the user may enter parameters for a new sort or filter. Additionally, in a request, a user may select a wide variety of different parameters. For example, a user may select a monitored power generating device or group of monitored devices for a sort or filter, the user may select one or more desired parameters for a sort or filter, and/or the user may select a time period to be examined for the sort or filter (e.g., the previous week, the previous month, a specific week other than the previous week, a specific month other than the previous month, etc.) Following the receipt of a user request for sorting, filtering, and/or displaying data at block 320, operations may continue at block 325.

At block 325, the data associated with the monitored power generating devices may be filtered or sorted in response to the received request. Additionally, the sorted or filtered data may be formatted for display to the user. In this regard, data associated with a plurality of power generating devices that is collected from multiple sources may be displayed to a user. Additionally, in certain embodiments of the invention, various reports or charts may be generated from the data and communicated to the user.

The method 300 may end after the operations of block 325.

The operations described in the method 300 of FIG. 3 do not necessarily have to be performed in the order set forth in FIG. 3, but instead may be performed in any suitable order. Additionally, in certain embodiments of the invention, more or less than all of the operations set forth in FIG. 3 may be performed. Furthermore, the operations set forth in FIG. 3 may be performed by any suitable control unit or combination of control units such as, a control unit.

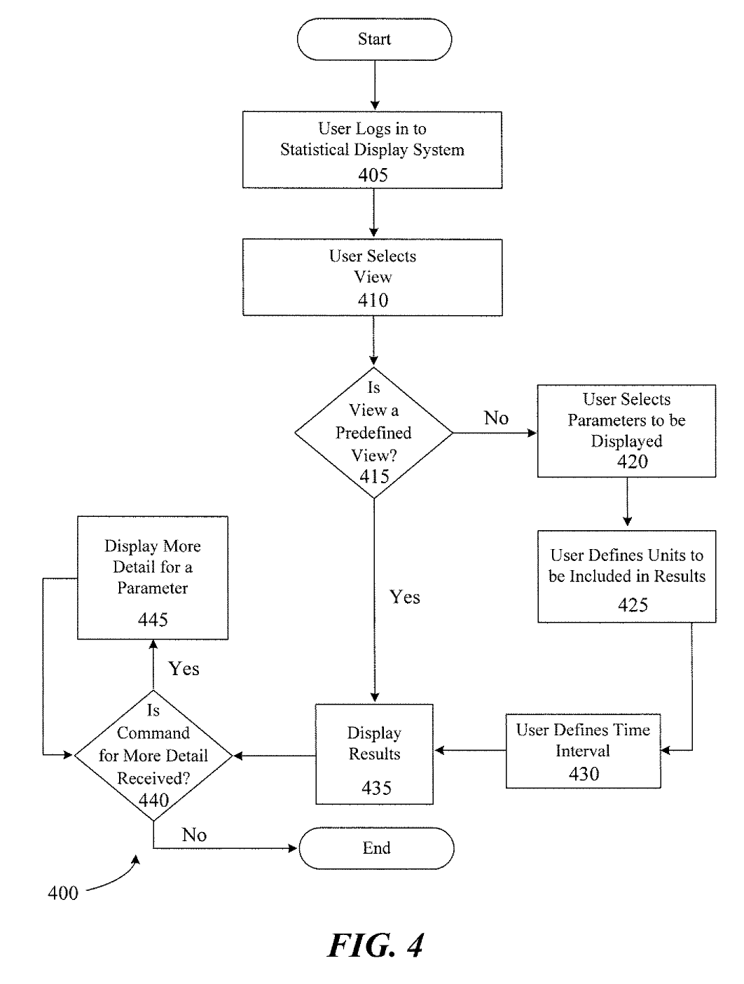

FIG. 4 is a flowchart of one example of a method 400 for displaying data associated with one or more monitored power generating devices, according to an illustrative embodiment of the invention. The method 400 may facilitate the selection of a sort or a filter for data associated with monitored power generating devices and the processing of the selection. The method 400 may begin at block 405.

At block 405, a user may log in to a statistical display system. In certain embodiments of the invention, a user may log into a statistical display system that is hosted by or associated with a data aggregator, such as aggregator 125 illustrated in FIG. 1A. Log in and/or security information, such as a user name and password may be provided to the statistical display system in order to identify and authenticate the user and permit access to data associated with monitored power generating devices. In various embodiments of the invention, the data that is accessible by a user may be determined based at least in part on the authentication of the user.

In embodiments of the invention that do not utilize a data aggregator, a security level may be associated with software operating on a user device, such as user device 135a, that facilitates the gathering of data from various data collection sources. Alternatively, log in and/or security information may be utilized to gather the data from the various data collection sources.

Once a user has logged in to a statistical display system or received collected data associated with monitored power generating devices, operations may continue at block 410. At block 410, the user may select a view for displaying data associated with one or more of the monitored power generating devices. The user may select a predefined view for displaying data or, alternatively, the user may define a new view for displaying data. The view may be selected in a variety of ways as desired in various embodiments of the invention. For example, a view may be selected from displayed view options, from a drop down menu, etc.

The selected view may determine the data associated with the monitored power generating devices that is displayed to the user. For example, the selected view may determine a monitored power generating device or group of monitored devices that are displayed, the parameters associated with the operation of the power generating device(s) that are displayed, and/or the period of time for which the parameters are displayed. In this regard, a user may compare parameters associated with the operation of one or more power generating devices.

Once the view is selected at block 410, operations may continue at block 415. At block 415, a determination may be made as to whether the selected view is a predefined view. If it is determined a block 415 that the view is a predefined view, then operations may continue at block 435 and the data associated with the predefined view may be displayed. If, however, it is determined at block 415 that the view is not a predefined view, then operations may continue at block 420 and a user may define a view for displaying data.

At block 420, the user may select one or more parameters associated with the monitored power generating devices for display. The one or more parameters may be selected in a wide variety of ways in various embodiments of the invention. For example, the one or more parameters may be selected from a list of available parameters for display. As another example, the one or more parameters may be selected from one or more drop down menus. Once one or more parameters have been selected at block 420, operations may continue at block 425.

At block 425, the user may select or define the units to be included in the display results. In other words, the user may select one or more power generating devices for the displayed results. The user may individually select power generating devices for display. Additionally, or alternatively, the user may select groups of power generating devices for display, such as, fleets or sub-fleets of power generating devices or power generating devices that are situated within a particular location or geographical area. Once the units have been selected at block 425, operations may continue at block 430.

At block 430, the user may select or define a time interval for display. The user may specify a beginning date and/or an ending date for the display. Alternatively, the user may select the current date as the ending date. Additionally, in some embodiments, the current date or the last day of the previous month may be utilized as a default ending date for the display. Once the time interval has been defined at block 430, operations may continue at block 435 and the requested data results may be displayed to the user.

At block 435, the predefined view or the selected preferences of the user may be processed. The collected data associated with the monitored power generating devices may be filtered and/or sorted in accordance with the selected preferences or the parameters associated with the predefined view. The filtered and/or sorted data may then be formatted for display to the user, and the results may be displayed.

Once the results have been displayed to the user at block 435, operations may continue at block 440 and a determination may be made as to whether a command for more detail has been received from the user. If it is determined at block 440 that no command for more detail has been received, then the method 400 may end. If, however, it is determined at block 440 that a command for more detail has been received, then operations may continue at block 445.

At block 445, the received command for more detail may be processed and a more detailed display may be formatted and presented to the user in accordance with the received command. A wide variety of different commands for more detail may be received in various embodiments of the invention. Additionally, the received commands may be processed in different ways. For example, a particular parameter may be selected and more detail for the selected parameter may be displayed, such as, the average values, relatively highest values, or other statistics associated the selected parameter. As another example, a particular power generating device may be selected and more detail for the selected power generating device may be displayed. Additionally, statistics associated with a group of power generating devices, such as, a fleet or sub-fleet of power generating devices, may be displayed with the detail for the selected power generating device. For example, a particular power generating device may be selected and more detail for the selected power generating device may be displayed. Additionally, statistical data for the fleet of power generating devices that in which the selected device is included may be displayed, such as, average performance data or relatively top performance data for the fleet.

Once more detail is displayed to the user at block 445, operations may continue at block 440 and a determination may be made as to whether an additional command for more detailed data is received. Alternatively, a determination may be made as to whether the user has selected a command to return to previously displayed results, such as, the results displayed at block 435.

The operations described in the method 400 of FIG. 4 do not necessarily have to be performed in the order set forth in FIG. 4, but instead may be performed in any suitable order. Additionally, in certain embodiments of the invention, more or less than all of the operations set forth in FIG. 4 may be performed. Furthermore, the operations set forth in FIG. 4 may be performed by any suitable control unit or combination of control units such as, a control unit.

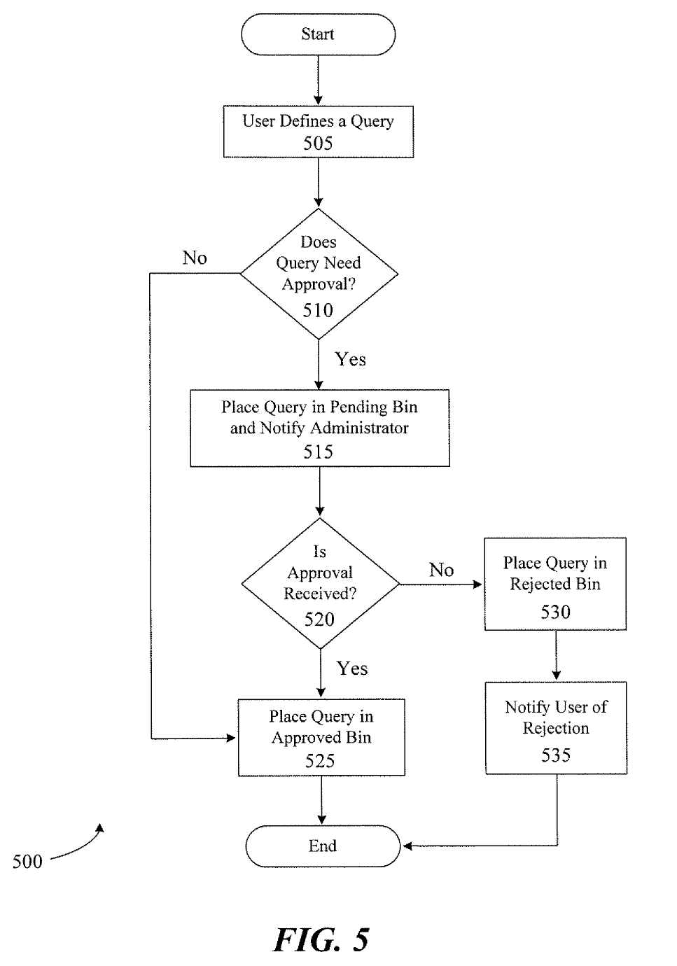

FIG. 5 is a flowchart of one example of a method 500 for defining user queries for data associated with one or more monitored power generation devices, according to an illustrative embodiment of the invention. In various embodiments of the invention, a user may define queries or filters for formatting data for display. These filters may require approval from a system administrator before data is formatted for display to the user. In this regard, security concerns associated with the requested data may be resolved prior to communicating data to the user. The system administrator may be a system administrator associated with a data aggregator, such as the data aggregator 125 illustrated in FIG. 1A.

The method 500 may begin at block 505 and a user may define a query. The query may specify the data parameters, time period, and/or power generating devices for a display requested by the user. Once the query has been defined by the user at block 505, operations may continue at block 510.

At block 510, a determination may be made as to whether approval for the defined query is required. In some embodiments, the data aggregator may determine whether any security concerns are associated with the defined query. For example, a determination may be made as to whether the user should be granted access to all or part of the data associated with a portion or all of the power generating devices defined by the query. The user may have access to data associated with the power generating devices owned or operated by the user; however, in some embodiments, the user may not have access to all of the data or any of the data associated with power generating devices that are not owned or operated by the user. Such a situation illustrates one example of when approval for a query may be desired.

If it is determined at block 510 that approval for a query is not needed or not required, then operations may continue at block 525. If, however, it is determined at block 510 that approval for the query is needed, then operations may continue at block 515. At block 515, the query may be planed in a pending query bin and a system administrator may be notified of the pending query. The system administrator may be notified in a variety of different way in accordance with various embodiments of the invention, such as, by e-mail or other electronic notification. The query may then be approved or denied by the system administrator. For some queries, in order to determine whether or not approve will be granted, the system administrator may solicit approval from other parties, such as, owners or operators of other power generating devices.

At block 520, a determination may be made as to whether approval has been received for the query. If approval is received for the query at block 520, then operations may continue at block 525. At block 525, the query may be placed in an approved bin. Once the query has been approved, data associated with the power generating devices may be filtered and/or sorted in accordance with the query and formatted for display to the user. The method 500 may then end following the operations of block 525.

If, however, approval for the query is not received at block 520, then operations may continue at block 530 and the query may be placed in a rejected bin. The user may then be notified of the rejection at block 535 by any appropriate method or technique, such as, by a pop-up message, an appropriate display, or e-mail notification. After then user has been notified of the rejection at block 535, the method 500 may end.

The operations described in the method 500 of FIG. 5 do not necessarily have to be performed in the order set forth in FIG. 5, but instead may be performed in any suitable order. Additionally, in certain embodiments of the invention, more or less than all of the operations set forth in FIG. 5 may be performed. Furthermore, the operations set forth in FIG. 5 may be performed by any suitable control unit or combination of control units such as, a control unit.

Various embodiments of the invention are described with reference to block diagrams of systems, methods, apparatuses and computer program products. It will be understood that each block of the block diagrams, and combinations of blocks in the block diagrams, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functionality of each block of the block diagrams, or combinations of blocks in the block diagrams discussed in detail in the descriptions below.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks. The computer program instructions may also be loaded onto a computer or other programmable data processing apparatus to cause a series of operational elements to be performed on the computer or other programmable apparatus to produce a computer implemented process such that the instructions that execute on the computer or other programmable apparatus provide elements for implementing the functions specified in the block or blocks.

Accordingly, blocks of the block diagrams support combinations of means for performing the specified functions, combinations of elements for performing the specified functions and program instruction means for performing the specified functions. It will also be understood that each block of the block diagrams, and combinations of blocks in the block diagrams, can be implemented by special purpose hardware-based computer systems that perform the specified functions or elements, or combinations of special purpose hardware and computer instructions.

Various embodiments of the invention may be implemented through an application program running on an operating system of a computer. Such embodiments also may be practiced with other computer system configurations, including hand-held devices, multiprocessor systems, microprocessor based or programmable consumer electronics, mini-computers, mainframe computers, etc.

Application programs that are components of embodiments of the invention may include routines, programs, components, data structures, etc. that implement certain abstract data types, perform certain tasks, actions, or tasks. In a distributed computing environment, the application program (in whole or in part) may be located in local memory, or in other storage. In addition, or in the alternative, the application program (in whole or in part) may be located in remote memory or in storage to allow for the practice of the invention where tasks are performed by remote processing devices linked through a communications network.

Many modifications and other aspects of the invention set forth herein will come to mind to one skilled in the art to which the invention pertains having the benefit of the teachings presented in the foregoing descriptions and the associated drawings. Therefore, it is to be understood that the invention is not to be limited to the specific aspects disclosed and that modifications and other aspects are intended to be included within the scope of the appended claims. Although specific terms are employed herein, they are used in a generic and descriptive sense only and not for purposes of limitation.

1. A method for displaying data associated with a plurality of power generating devices, comprising:
collecting, from a plurality of data sources, data associated with the operation of the plurality of power generating devices;
receiving a user request to display data associated with one or more of the plurality of power generating devices; and
formatting the requested data for display to the user in response to the received request.

2. The method of claim 1, further comprising:
collecting other data associated with the plurality of power generating devices from one or more additionally data sources.

3. The method of claim 1, wherein at least one of the plurality of data sources includes information gathered by monitoring the operation of one or more of the plurality of power generating devices.

4. The method of claim 1, wherein receiving a user request comprises receiving a selection of a predefined view for displaying data.

5. The method of claim 1, wherein receiving a user request comprising receiving a user request to filter the collected data for display.

6. The method of claim 5, wherein receiving a user request to filter the collected data for display comprises receiving at least one of an indication of the one or more power generating devices of the plurality of power generating devices, an indication of a time period for display, or an indication of one or more parameters associated with the one or more power generating devices of the plurality of power generating devices.

7. The method of claim 5, further comprising storing the received user request to filter the collected data for display.

8. The method of claim 5, further comprising:
implementing an approval process for the received user request prior to formatting the requested data for display.

9. The method of claim 1, further comprising displaying the formatted data to the user.

10. The method of claim 9, wherein the displayed data comprises at least one comparison between a first of the plurality of power generating devices and a second of the plurality of power generating devices for at least one operating parameter associated with the first and second power generating devices.

11. A system for monitoring a plurality of power generating devices, comprising:
at least one memory operable to store data associated with the operation of the plurality of power generating devices, wherein the data comprises data collected from a plurality of data sources; and
at least one processor operable to (i) receive a user request to display data associated with one or more of the plurality of power generating devices, (ii) access the at least one memory to retrieve the requested data, and (iii) format the request data for display to the user.

12. The system of claim 11, wherein the at least one memory is further operable to store other associated with the plurality of power generating devices that is collected from one or more additional data sources.

13. The system of claim 11, wherein at least one of the plurality of data sources includes information gathered by monitoring the operation of one or more of the plurality of power generating devices.

14. The system of claim 11, the received user request comprises a selection of a predefined view for displaying data.

15. The system of claim 11, wherein the received a user request comprises a user request to filter the stored data for display.

16. The system of claim 15, wherein the received user request to filter the stored data for display comprises at least one of an indication of the one or more power generating devices of the plurality of power generating devices, an indication of a time period for display, or an indication of one or more parameters associated with the one or more power generating devices of the plurality of power generating devices.

17. The system of claim 15, wherein the processor is further operable to direct the at least one memory to store the received user request to filter the collected data for display.

18. The system of claim 15, wherein the processor is further operable to implement an approval process for the received user request prior to formatting the requested data for display to the user.

19. The system of claim 11, wherein the formatted data is displayed to the users and
wherein the displayed data comprises at least one comparison between a first of the plurality of power generating devices and a second of the plurality of power generating devices for at least one operating parameter associated with the first and second power generating devices.

20. The system of claim 11, wherein the formatted data is displayed to the user, and
wherein the displayed data comprises at least one comparison of at least one operating parameter for a first of the plurality of power generating devices to an average value of the at least one operating parameter for the plurality of power generating devices.
